(19) United States
(12) Patent Application Publication
(10) Pub. No.: US 2010/0213228 A1
(43) Pub. Date: Aug. 26, 2010

(54) SYSTEM AND METHOD FOR PROVIDING AN ARTICLE ORGANIZER TO A RECREATIONAL VEHICLE

(75) Inventor: Chris Dannewitz, McKinleyville, CA (US)

Correspondence Address: NOVAK DRUCE AND QUIGG, LLP (Thule), 1000 LOUISIANA STREET, FIFTY-THIRD FLOOR, HOUSTON, TX, 77002, US

(73) Assignee: THULE SWEDEN AB, Hillerstorp (SE)

(21) Appl. No.: 12/374,638

(22) PCT Filed: Jul. 18, 2007
(86) PCT No.: PCT/US07/16324

§ 371 Date: Apr. 13, 2010

Related U.S. Application Data
(60) Provisional application No. 60/807,690, filed on Jul. 18, 2006.
(60) Provisional application No. 60/823,077, filed on Aug. 21, 2006.

(51) Int. Cl. B60R 9/00

(52) U.S. Cl. 224/401; 224/547

(57) ABSTRACT

Systems, arrangements and methods that permit accessories, sub-systems and related articles to be releasably mounted at a surface of an recreational vehicle so that a suspended object can be variously located about the vehicle. The system accommodates mounting the article at various locations about the recreational vehicle utilizing a plurality of receivers configured to be at least semi-permanently coupled to an exterior surface of the recreational vehicle. Each of the receivers are adapted to releasably receive an insert member associated with an article to be suspended from the vehicle at a location proximate the respective receiver.

### TECHNICAL FIELD

The present invention relates generally to a system for organizing and mounting equipment on mounting surfaces. More specifically the invention relates to coupling devices for use with transporting vehicles, particularly recreational vehicles, to attach different articles and devices at mounting locations about the recreational vehicle.

### BACKGROUND

Recreational pursuits are becoming an evermore important part of today's leisure lifestyles. As a result, recreational products, including recreational vehicles and the various associated systems and accessories, are becoming an increasingly attractive product category.

The present disclosure appreciates that most recreational vehicles (RVs), whether motorized or towed, frequently have accessories permanently mounted to their exterior. One example is the ladder that is typically mounted to the back of the vehicle so that the operator can climb from ground-level up to the roof of the vehicle for securing cargo, as well as performing maintenance and repair to systems located atop the vehicle. The present disclosure further appreciates the desirability of being able to use such an accessory as the described ladder at other locations about the vehicle; for instance, at the front of the vehicle to clean the windshield which will normally be out of most operator's reach from ground-level. Therefore, the need has been recognized for a means that accommodates variously locating such things as a ladder at varied locations (back, front and sides, depending upon the need) about the vehicle.

In the many and varied pursuits to develop means for attaching articles to vertically planar surfaces (usually walls), hooks, fasteners, and nails are often used for hanging objects on walls. Reliable means for securing heavy objects directly to the planar surface include screws, bolts and the like. Direct attachment of an object to a wall, however, has the disadvantage that later repositioning of the object into a different position or location requires removal of the screw or bolt or similar permanent fastener to release the object from the wall or other mounting surface.

Releasable attachment of objects in the form of displays is known (US Published Application 2002162925 A1) wherein a wall attachment device allows easy replacement of a display hung on a wall. The wall attachment device provides secure hanging of display objects releasably on a wall.

As described, the wall attachment device is a display holding apparatus comprising a pair of plate members. A first plate member, mountable on a wall surface, uses screws or nails to secure the first plate member to the wall surface. The first plate member has a recessed portion defining a cavity therein to receive a second plate member comprising a catch member protruding from a rearward side thereof. A head portion of the catch member has a size and shape to slide into and fit substantially tight within the cavity of the first plate member.

The second plate member connects, to the first plate member with the rearward side of the second plate member abutting the front side of the first plate member. Releasable attachment of a display to a wall occurs by attaching the display media to protrude from the front side of the second plate member.

Previous description of a wall attachment device, limiting its use to displays, provides no clear suggestion of how the display attaches to the front side of the second plate member. The description and associated drawings limit the disclosure substantially to interlocking disc-like structures. There appears to be no structural modification of the first plate member and optional structures integrally formed with the front side of the second plate member appear to be limited to a rod member, a hook member and a support bar (EP 0 791 314 B1).

In view of the above-described limitations associated with known designs for releasable attachment devices, the present invention has been developed to increase the utility of such devices and provide further benefits to the user. Such benefits include devices having optional structures for increased functionality. These enhancements and benefits are described in greater detail hereinbelow with respect to several alternative embodiments of the present invention.

### DISCLOSURE OF THE INVENTION

The present invention in its several embodiments alleviates the drawbacks described above with respect to previous disclosure of interlocking plate coupling devices and incorporates several additionally beneficial features. A releasable coupling device according to the present invention provides a variety of ways for organizing; storing, transporting and using accessories suitably adapted for use with recreational vehicles (RV), for example. Distribution of components of multiple coupling devices over surfaces of the recreational vehicle facilitates equipment organization using a mounting system that allows easy release of the equipment when the RV is parked, yet provides secure storage and organization of the equipment optionally against vertical surfaces inside and outside the RV when the vehicle is in motion between campsites or other stationary use locations.

A releasable coupling device according to the present invention comprises a first coupling member, also referred to herein as a pod, that has secure, substantially permanent attachment to a mounting surface, typically a vertical surface. As used herein, the term “hard point” refers to the first coupling member secured to the surface. The releasable coupling device further comprises a second coupling member adapted to provide connection for a variety of interchangeable accessories. Accessories suitable for attachment to the RV include, but are not limited to, ladders, awnings, canopies, storage bins and boxes, tables, chairs, barbecues, and recreational equipment, such as skis, bicycles, canoes, dirt bikes, and the like. Terms such as, “hard point insert,” “fastener” and “mechanical fastener” or the like refer herein to the second coupling member that, upon coupling to the pod or hard point completes connection of a selected accessory to the surface of the RV.

Among the several disclosed inventions in the present disclosure, at least one embodiment takes the form of a method for accommodating varied placement of a hanging article about a recreational vehicle. The method includes providing a number (plurality) of hanger-receiver locations on at least one substantially vertical surface (for example, an interior or exterior sidewall) of a recreational vehicle and the several (plurality) hanger-receiver locations provide a number (plurality) of releasable hanging positions for a hanging article about the recreational vehicle.

In this embodiment, each hanger-receiver location is provided in a mounted member that is semi-permanently fixed to a substantially vertical surface of the recreational vehicle. In one illustrative example, each hanger-receiver location includes a trap-space in which a necked hanger connected to the hanging article inserts in releasable, trapped engagement therewith. An example of such an interconnection is illustrated in FIGS. 1 and 2 where an eye-pin is shown with an expanded flat head opposite the eye, and the flat head slips into an interior trap space of the mounted member for releasable engagement therewith. Instead of a trap-space, it is also contemplated that a more generic receiving space may be included in the mounted member that accepts an insert portion of the hanger of an article.

In another aspect the disclosed invention takes the form of a method for providing sets of hanger-receivers that when installed, provide a plurality of locations that accommodate varied placement of a hanging article about a recreational vehicle. The method includes obtaining a plurality of hanger-receivers and advocating the sale of the hanger-receivers to third parties in sets of at least two hanger-receivers. The term “advocating” is selected to denote that fact that direct advertising of the product's use may be utilized, product instructions may be utilized and it is also contemplated that the intended use may be more subtlely advocated such as through illustrative pictures of such end uses and applications. Similarly, semi-permanent installation is advocated of sets of the hanger-receivers at different locations about a recreational vehicle on substantially vertical surfaces thereof to thereby enable a user of the incorporating recreational vehicle to establish a plurality of releasable hanging positions for a hanging article about the recreational vehicle.

In an alternative embodiment, a mounting system according to the present invention includes hard points distributed, for example, over a wall or the skin of a recreational vehicle or other convenient surface, also referred to herein as the mounting surface. Suitable positioning of hard points facilitates attachment of ladders and the like to the mounting surface. In this example, the ladders are equipped with hard point inserts that align with and engage a plurality of provided hard points for releasable attachment at selected locations on the mounting surface of a wall or RV. A benefit of the mounting system is the capability for moving hung objects such as ladders to different hard points distributed over the mounting surface. It will be appreciated that releasable attachment of ladders is beneficial for storing the items, as well as providing safety and security when the ladders are in use around the RV.

In alternative embodiments according to the present invention the mounting system facilitates attachment of accessories, other than ladders, to suitable mounting surfaces. In the case of recreational vehicles, a useful accessory is a storage bin or box sized to provide units of varying capacity. Storage boxes attached to the outside of the vehicle advantageously augment the limited cargo space usually found in RVs. Cargo limitation occurs when the RV includes slide-out room sections that tend to reduce interior space. The use of releasable couplings, wherein the pod is attached to the mounting surface and the hard point insert is affixed to the accessory, e.g. the storage bin or box, allows attachment of the accessory to the RV. Depending on the size of the accessory, attachment can occur at either the rear or the side of the vehicle. For example, the rear of the RV is an appropriate position to attach a large modular storage bin or box designed to include modules for fishing and hunting equipment. The size and weight of the box will determine the need for two or more releasable coupling devices for secure attachment to the RV.

The use of the mounting system using releasable coupling devices will be appreciated as applicable to storage situations that require attachment of a variety of articles to mounting surfaces inside and outside of a transporting vehicle. Attachment requirements will differ depending on whether or not the RV is loaded for transportation between camping locations or is parked with items deployed for use during a stay at a camping site or similar destination. The mounting system according to the present invention is suitable for secure storage during motion of the RV and for convenient attachment of accessories needed when the RV is used for accommodation at an RV park, for example. Accessories for deployment around the parked RV, and that can be attached to the RV, include awnings, tables, shelves, containers and the like, each being attached to the vehicle using releasable coupling devices according to the present invention.

The first coupling member of a releasable coupling device configured according to the present invention, also referred to herein as a pod, is adapted for secure releasable attachment of an accessory to a mounting surface, typically a vertical surface. The first coupling member or pod has a variety of structures including arcuate and elongate forms. A useful pod structure includes a housing having a movable cover that upon deflection provides access to a receiving pocket for the mating engagement of the second coupling member or fastener. The receiving pocket has a shape selected from shapes including but not limited to circular shapes, U-shapes, and rectangular shapes.

In an alternative pod structure, also referred to herein as a rod pod, the movable cover slides relative to the housing to reveal a bar or rod suitable for engagement by a mating fastener affixed to an accessory and which is used to attach the accessory to the mounting surface of the RV. Covers used to protect pockets, bars, rods and the like include spring-biased covers that act as closures to prevent ingress of moisture or foreign material. Some embodiments of the first coupling member omit the cover portion to allow direct access to a receiving pocket or bar. In other embodiments, the pocket or bar is an integral part of a post or girder or channel of the RV body.

The second coupling member or hard point insert has a design for mating engagement with a matching pod. A general form of hard point insert may be described as any structure designed for hanging retention in the pocket or over the bar or rod of one of the pod structures described previously. Hook shaped articles and variations thereof are suitable mechanical fasteners for hanging engagement and retention by pods according to the present invention. Materials suitable for shaping into hook-like structures include metal, plastic, and reinforced plastic fiber, rod, plate and molded structures including posts having enlarged heads integrally formed therewith to provide mushroom-shaped mechanical fasteners suitable for trapped engagement with pods having open slots or arcuate receiving pockets, among others.

More particularly, the present invention provides an article organizing and mounting system comprising a mounting surface and a releasable coupling device including a first releasable coupling member providing a hard point when secured to the mounting surface. The hard point allows releasable engagement by a second releasable coupling member that has a connection to the article to mount the article adjacent to the mounting surface.

One embodiment of the present invention uses an article organizing and mounting system wherein the first coupling member is a pod including a housing and a pocket to receive a mating portion of the second coupling member to produce the releasable coupling device attaching the article to the mounting surface. This embodiment optionally includes a cover for the pocket. The cover is adapted to deflect or open to provide access to the pocket for the mating portion of the second coupling member. As an option, the mating portion includes a flat head portion for engaging the pocket for releasable retention therein. The mating portion further includes a stem portion between the flat head portion and the connection to the article.

An alternate article organizing and mounting system according to the present invention uses a releasable coupling device wherein the first coupling element is a rod pod including a housing and a rod to receive a mating portion of the second coupling member to attach the article to the mounting surface. The first coupling member further includes a sliding cover movable to present the rod for releasable engagement of the mating portion of the second coupling member. As an option, the mating portion includes a clamp portion for engaging the rod for releasable retention thereto. The mating portion further includes a stem portion between the clamp portion and the connection to the article.

The article organizing and mounting system may be used with a variety of articles selected from the group consisting of an awning, a ladder, a sports equipment carrier, a barbecue grill, a shelf and a storage container and the like. Such items have use for travelers and camping enthusiasts using a recreational vehicle, for example, wherein the mounting surface is a surface portion of the recreational vehicle. The surface portion to which an article may be attached using the organizing and mounting system according to the present invention may be an inside portion or an outside portion of the recreational vehicle.

The beneficial effects described above apply generally to the exemplary devices and mechanisms disclosed herein of the system for mounting accessories on mounting surfaces available inside and outside of RVs. The specific structures through which these benefits are delivered will be described in detail hereinbelow.

### BRIEF DESCRIPTION OF THE DRAWINGS

Aspects of the disclosed invention(s) are depicted in the appended drawings showing exemplary embodiments thereof.

FIG. 1 is a perspective view depicting a mounting system configured according to the present invention including semi-permanent coupling devices distributed over surface(s) of a recreational vehicle to facilitate attachment of a variety of accessories thereto.

FIG. 2 is a side elevation showing an exploded view of first and second coupling members of a releasable coupling device configured according to the present invention.

FIG. 3 is a perspective view depicting the mounting system according to the present invention including alternative releasable coupling devices distributed over the surface of a recreational vehicle to facilitate attachment of a variety of accessories thereto.

FIG. 4 is a perspective view showing the use of the mounting system according to the present invention for attaching a storage container to the rear of the recreational vehicle.

FIG. 5 is a perspective view illustrating a mechanical fastener used to attach a hook to a receiving pocket formed in a post or girder of a recreational vehicle. The hook facilitates organization of articles for transportation and during a stay at a campsite.

FIG. 6 is a perspective view showing another type of releasable coupling devices that as shown also facilitates storage and stabilization of sports equipment and other articles (ladder) inside and outside a transporting vehicle.

FIG. 7 is a perspective view showing additional forms of releasable coupling devices that facilitate storage of sports equipment inside a transporting vehicle and a folding ladder outside the vehicle.

FIG. 8 is a perspective view showing the versatility of the mounting system according to the present invention for attaching and organizing accessories around a recreational vehicle used for temporary accommodation during a visit to a campsite or similar destination.

FIG. 9 discloses a hook installed in a unique receiver-insert arrangement at interior locations within a “garage” of a vehicle.

FIG. 10 shows a configuration for increasing storage locations on an RV that has a drop-down door.

FIGS. 11-15 disclose a number of releasable mounting systems shown on towed camping trailers.

FIGS. 16-18 show different systems for affecting variously configured mountings inside a vehicle.

FIGS. 19-21 show swinging arrangements that can be variously mounted to the vehicle, and through which further versatility is provided to the user.

FIGS. 22-23 variously illustrate an “elongate support track” concept in which an elongate receiver is provided of substantially uniform cross section and upon which various attachments can be made.

FIGS. 24-31 alternatively illustrate an “elongate support track” having discreet hanger-receiver locations in the pair of extruded aluminum support bars that also enable variously hanging different hanger-based arrangement off of the vehicle.

### DETAILED DESCRIPTION

As required, detailed embodiments of the present invention are disclosed herein; however, it is to be understood that the disclosed embodiments are merely exemplary of the Invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

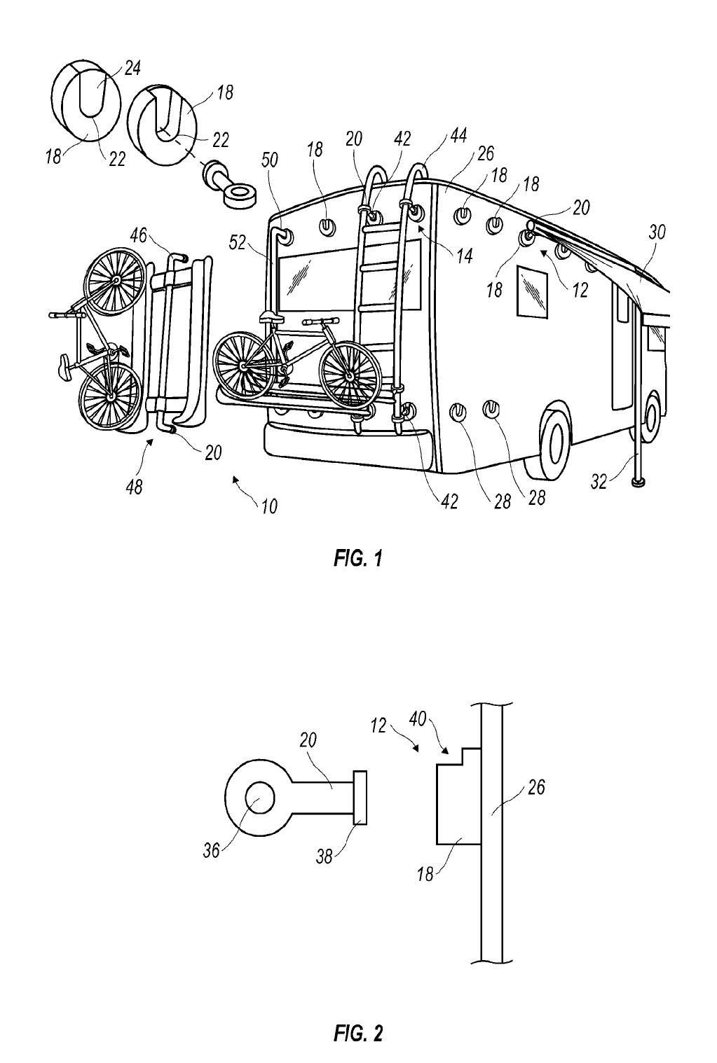

Referring to the figures, wherein like numbers refer to like parts throughout the several views, FIG. 1 shows a perspective view depicting the mounting system 10 according to the present invention including releasable coupling devices 12, 14 distributed over the surface of a recreational vehicle 16 to facilitate attachment of a variety of accessories thereto. The mounting system includes a first releasable coupling member 18, also referred to herein as a pod. A second releasable coupling element 20, engages the pod to form a secure, releasable coupling between the first and second coupling element, which herein is also referred to as either a hard point insert, or fastener or mechanical fastener. The pod 18 has the shape of a disc from which a U-shaped segment 22 has been removed. A cover 24 fits into the U-shaped segment 22 and moves between a closed position and an open position to accommodate insertion of the fastener 20 during formation of releasable coupling devices 12, 14. Substantially permanent attachment of a pod 18 to a mounting surface 26 of the RV produces a hard point 28 to receive a hard point insert or fastener 20 for attaching an accessory to the RV.

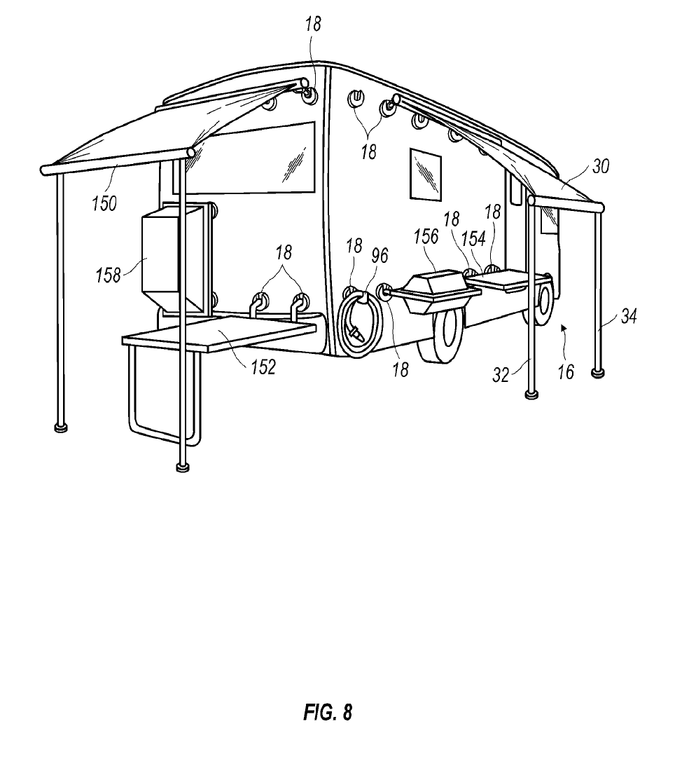

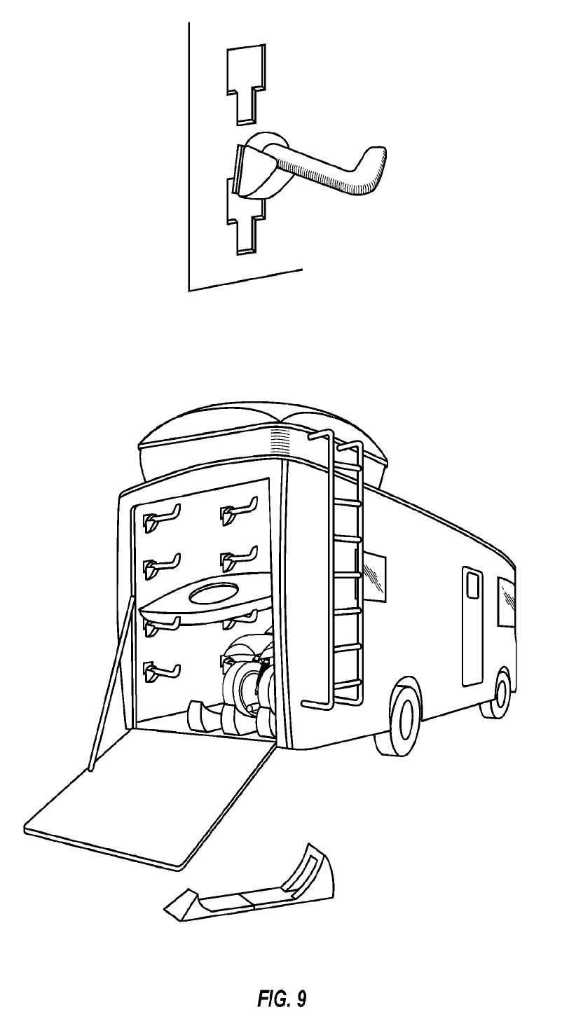

FIG. 1 illustrates attachment of a variety of accessories to the outside of a RV by formation of releasable couplings 12, 14 at hard points distributed around the RV 16. An awning 30 (see FIG. 8) is an accessory that finds frequent use by RV users to provide shade from the sun and protection from inclement weather. As illustrated in FIG. 8, the awning 30 extends from the side of the RV 16 to two support poles 32, 34 (see FIG. 8). Releasable attachment of the awning 30 to the RV 16 uses a releasable coupling system according to the present invention wherein a fastener 20 releasably inserted in a pod 18, at each end of the awning 30, provides secure attachment of the awning 30 to the RV 16 until disassembly and stowage of the awning 30 in preparation for moving the RV 16 to the next destination.

FIG. 2 is a side elevation showing an exploded view of a releasable coupling device 12 that includes a pod 18 secured to a mounting surface 26 to provide a hard point for attachment of an accessory using a fastener 20 designed for use with the accessory, such as an awning 30. The fastener illustrated in FIG. 2, has an eyelet 36 providing a point at which to tie the fabric of the awning 30 using thread rope or a hook or a drapery ring or the like. After tying the fastener 20 to the awning 30, insertion of the flat-headed portion 38 of the fastener 20 into the pocket 40 of the pod 18 results in the desired releasable attachment of the awning 30 to the side of the RV 16, as shown in FIGS. 1 and 8.

The eyelet 36 that is the connective element of the fastener 20, described in FIG. 2, could be substituted by other connective elements to facilitate attachment of other accessories to the mounting surface 26 of the RV 16. FIG. 1 includes optional fastener 20 structures that include a clamp 42 used in suitable number to attach a ladder 44 to the RV 16. Further evidence of the versatility of the mounting system 10 according to the present invention is the provision of a fastener 20 that includes a connective element in the form of a receiving tube 46 for attaching a bicycle carrier 48 to the outer surface of the RV 16. As an alternative to the receiving tube 46, the connective element could be in the form of a plug (not shown) that provides a friction fit when introduced into a pipe end 50 to provide attachment of a handrail 52 to the RV 16, using releasable attachment of a fastener 20 to a pod 18.

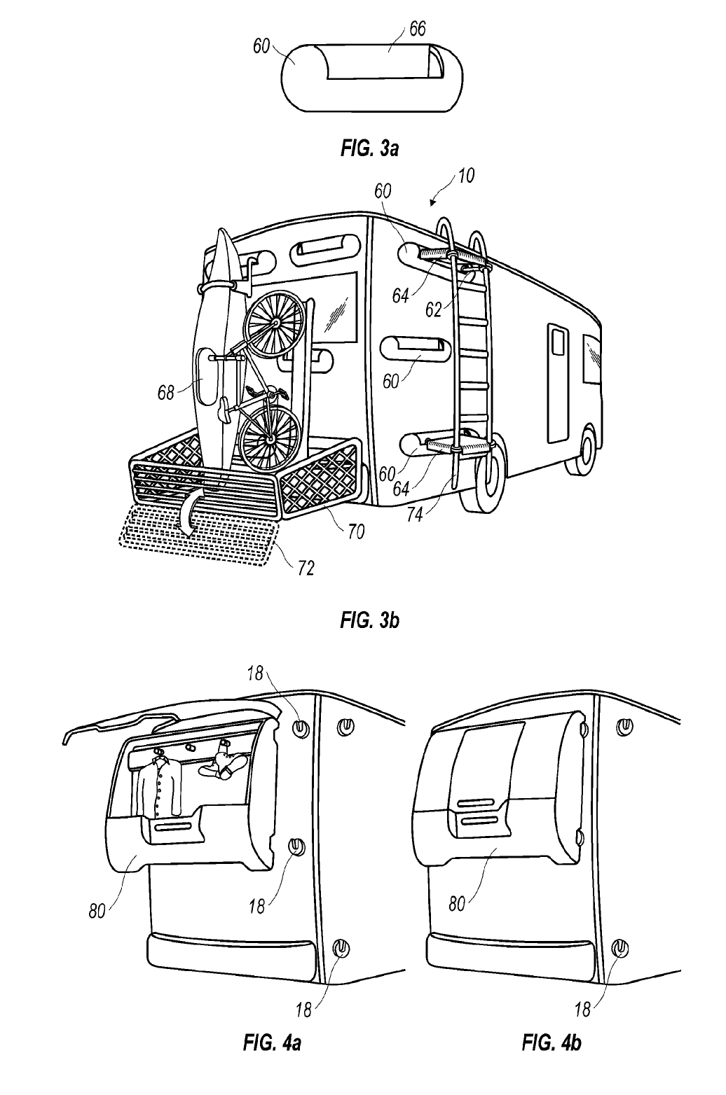

FIG. 3 provides a perspective view depicting the mounting system 10 according to the present invention including alternative elongate pods 60 distributed over the surface of a recreational vehicle to facilitate attachment of a variety of accessories thereto. An elongate fastener 62 is a planar element having a hooked edge 64 causing deflection of a protective cover 66 as the elongate fastener 62, engages the elongate pod 60 for secure releasable attachment of large accessories. Optional large accessories include a canoe 68, carrier basket 70 that could include a pivoting gate 72 and an alternate ladder 74 and a bike rack 76 and the like.

FIG. 4 is a perspective view indicating the use of a plurality of pods 18 to attach a large storage container 80 to the rear of the recreational vehicle. The fastener (not shown) resembles the fastener 20 shown in FIG. 2 except that the connective element differs from the eyelet 36. While retaining the flat-headed portion 38, the connective element of the fastener 20 has options depending on the connecting element chosen to join the fastener 20, to the large storage container 80. Suitable connecting elements to replace the eyelet 36 of FIG. 2 include, but are not limited to, nut and bolt combinations, hooks, screw clamps, and spring clamps and the like known to those having skill in the art.

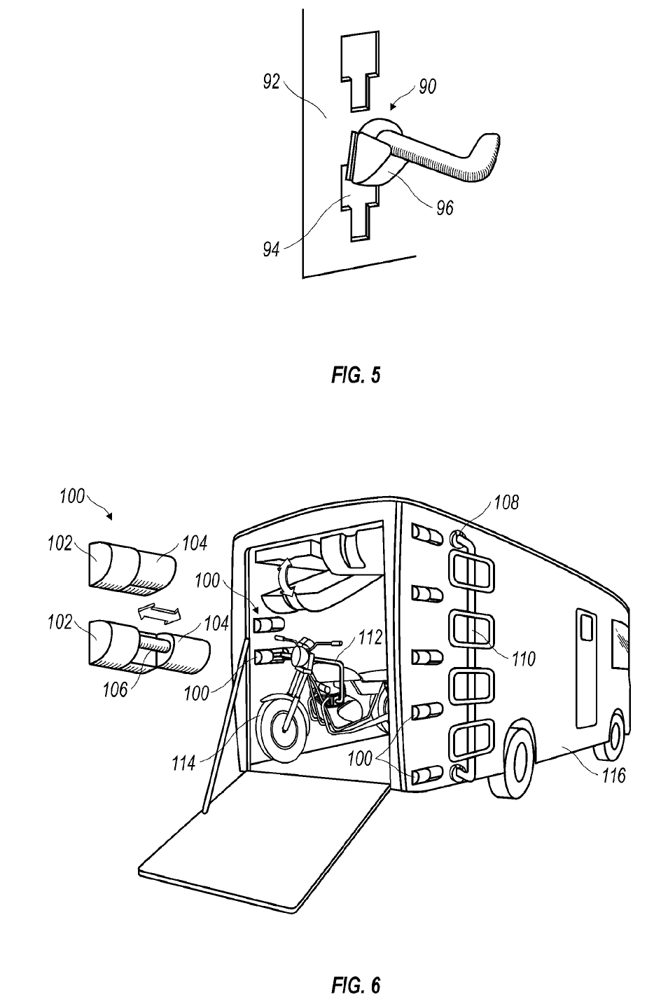

FIG. 5 provides illustration of a releasable coupling device 90 having a different structure from releasable coupling devices described previously. The embodiment of FIG. 5 does not use a pod 18 secured to a mounting surface 26 of an RV 16. Instead of a separate pod 18 that includes a pocket 40, a structural portion 92, such as a post or girder of a recreational vehicle, has an opening 94 sized to receive the flat-headed portion 38 of a fastener 20 that includes a hook 96 instead of an eyelet 36. The hook 96 facilitates organization of articles for transportation and during a stay at a campsite.

FIG. 6 is a perspective view showing a rod pod 100 that differs from the pods 18 described above and that include a pocket 40 to receive a flat-headed portion 38 of a hard point insert or fastener 20. The rod pod 100 includes a housing 102 having an optional sliding cover 104 that slides relative to the housing 102 to reveal a bar or rod 106 suitable for engagement by a clamping or hanging fastener 108 affixed to an accessory, shown as a ladder pole 110. The ladder pole 110 has a hooked/clamping/latching fastener 108 at each end for releasable mating engagement with the rod 106 of a rod pod 100 when the sliding cover 104 is open. The fasteners 108 at each end of the ladder pole 110 matingly engage the rod 106 of the rod pod 100 for releasable attachment of the ladder pole 110 to the side of the RV 16. Attachment of a suitable fastener 108 to a bracing bar 112 that engages a rod pod 100 provides means to immobilize a piece of sports equipment, such as a dirt bike 114, against an interior wall of the transporting vehicle 116 as shown in FIG. 6.

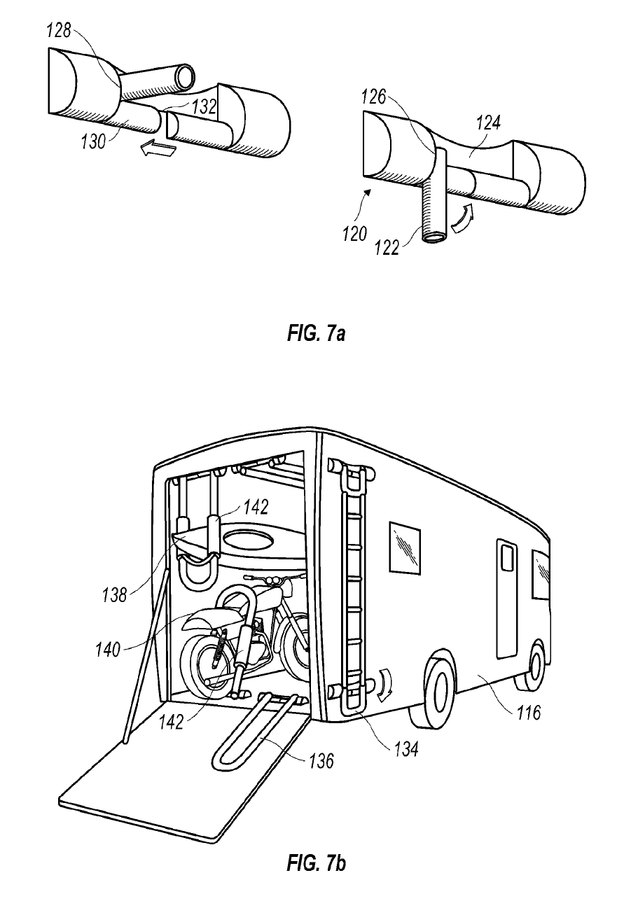

FIG. 7 is a perspective view showing a unitary coupling device 120 having an elongate fastener 122 coupled to a pod bracket 124 for pivotal movement between a folded position 126 and an extended position 128. The unitary coupling device further includes a slider 130 movable in a channel 132 of the pod bracket 124 to restrict movement of the elongate fastener 122 once it is set in the extended position 128. Suitable elongate fastener 122 designs include tubes, rods, and brackets and similar structures capable of mating engagement with the pod bracket 124. One embodiment of a mounting system according to the present invention is the use of several unitary coupling devices for attaching a folding ladder 134 to the side of a transporting vehicle 116. Another embodiment shows the use of unitary coupling devices 120 with U-shaped racks 136 used in the storage of relatively large watercraft 138 and off-road vehicles 140, for example. The U-shaped rack 136 is formed between a pair of elongate fasteners 122 that pivot relative to the respective pod brackets 124. A tubular cushioning sleeve 142 prevents damage to watercraft 138 and off-road vehicles 140 and similar recreational equipment. The combination of unitary coupling devices 120 with U-shaped racks 136 facilitates storage of sports equipment inside the transporting vehicle 116.

FIG. 8 provides a perspective view showing the versatility of a mounting system configured according to the present invention for attaching and organizing accessories around a recreational vehicle while parked at a campsite. Pods 18 of the type described in FIG. 1 and FIG. 2 occupy positions of hard points distributed around the side and rear of the RV 16 to provide points of attachment for a first awning 30, a second awning 150, a table 152, a shelf or counter top 154, a barbecue grill 156 and a storage container 158 that could be used as a pantry. Pods 18 as depicted in FIG. 1 are shown for purposes of illustration, however, it will be appreciated that the mounting system according to the present invention could use any of the releasable coupling devices described above.

A mounting system and its components have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

The presently described systems, arrangements and methods have as a goal to permit accessories, sub-systems and related articles to be releasably mounted about an RV, and most preferably, these systems, arrangements and methods accommodate variable location of the accessories, sub-systems and related articles in and on the vehicle.

Referring again to FIG. 1, a number of mounting receivers (pods) are located about the exterior of the RV, and which are configured for releasably receiving mounting inserts from an article to be mounted thereto, such as the illustrated ladder, bicycle rack and awning. For added security, a closing arrangement can be included as part of the receiver for securing the mounting insert until intended disengagement. As may be readily appreciated from the illustration, the several mounted articles can be variously mounted about the vehicle at different locations. It is contemplated that the receiver-insert system can be used both when the vehicle is stationary and when traveling. Importantly, the mounting system allows versatility that has heretofore been unknown in the recreational market.

FIG. 3 depicts a trough-like receiver that can receive elongate inserts, as well as multiple narrower inserts, possibly even from multiple accessories simultaneously hung thereupon.

FIG. 4 illustrates a pre-packable box that can be hung from the vehicle and easily dismounted for local portage, on-site.

FIG. 6 depicts a concealable bar that can be used as a mounting receiver as shown.

FIG. 7 shows pivot mounts inside the vehicle, as well as a downwardly folding, collapsible ladder outside the vehicle. It should be further appreciated that the mounting systems disclosed herein can be used separate from an RV, but at least in association therewith. As one example, similar mount receivers might be located in the user's garage for storing the articles when not being used in conjunction with the RV. As another example, the mountings can be installed at a camping ground so that different users can make use of the receivers at different times.

FIG. 8 depicts a number of exemplary embodiments of the several inventive concepts disclosed herein showing how a user can variously mix and match different articles and systems about an appropriately adapted vehicle according to the disclosures contained herein. This depiction also illustrates the wide array of associated articles and systems that can be associated with the primary hanging system for developing far-reaching product lines capable of satisfying the recreational markets.

FIG. 9 discloses a hook installed in a unique receiver-insert arrangement at interior locations within a “garage” of a vehicle. FIG. 9 also shows an outwardly folding ladder installed partially on the vehicle and partially on a vehicle-mounted cargo box atop the vehicle. As shown, the ladder is capable of swinging (pivoting) into a collapsed configuration, snug against the exterior of the vehicle in a travel configuration.

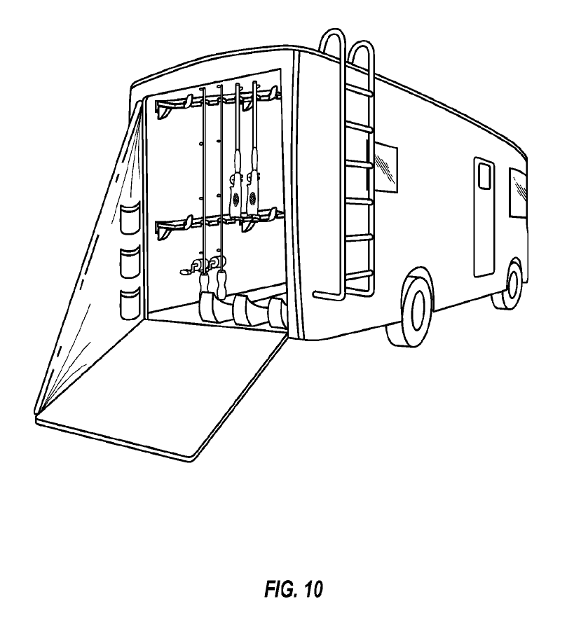

FIG. 10 shows a configuration for increasing storage locations on an RV that has a drop-down door. The illustrated example discloses pockets installed on flexible walls spanning the distance between the folded-down door and the vehicle.

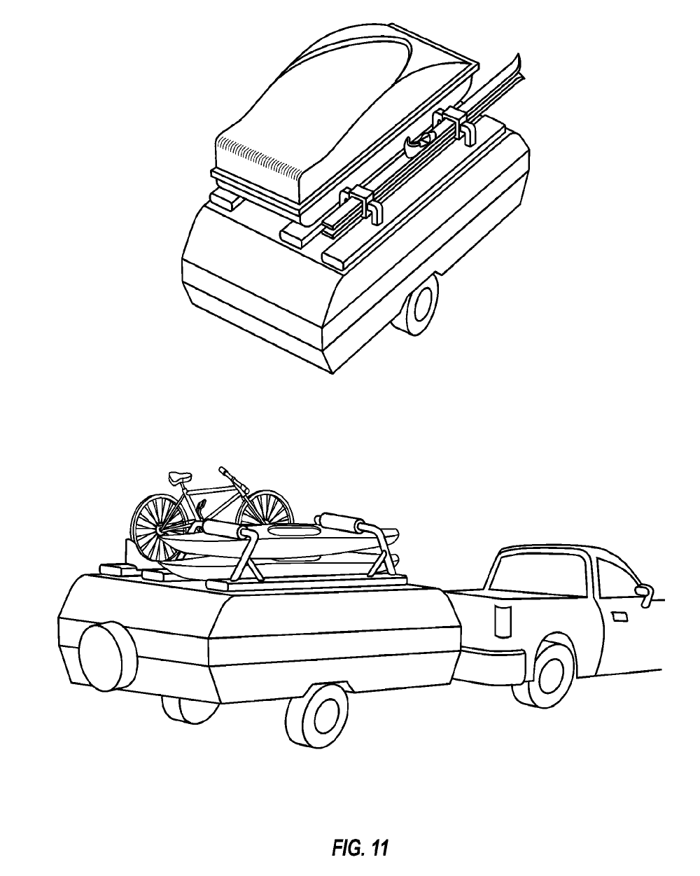

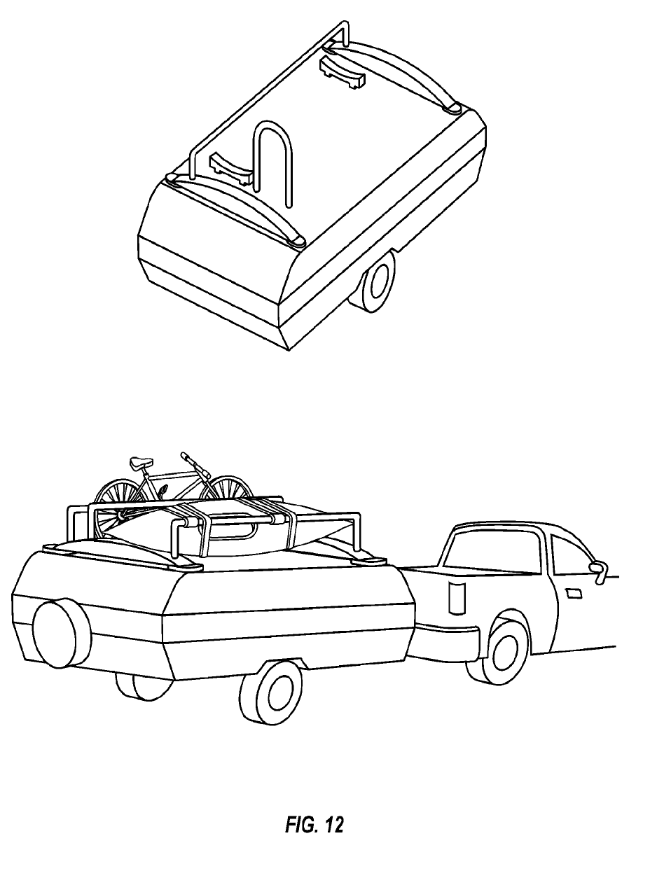

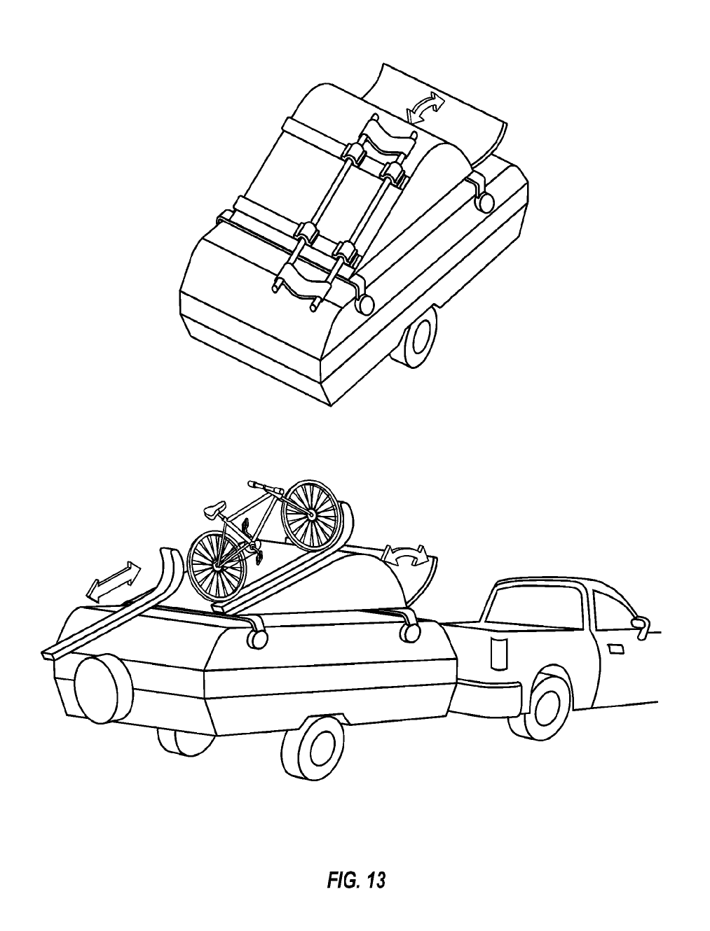

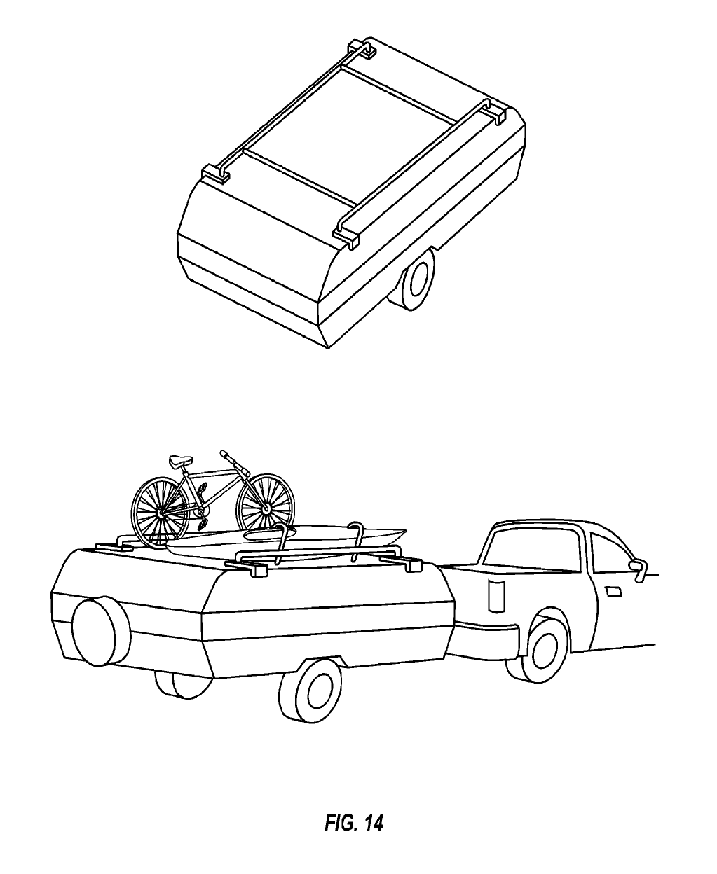

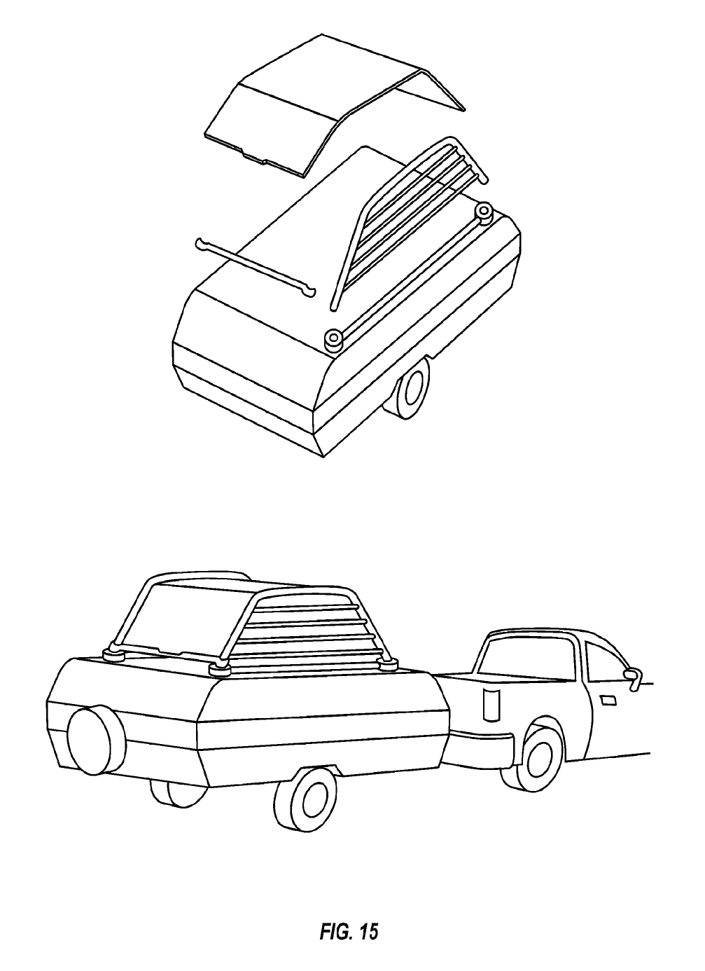

FIGS. 11-15 disclose a number of releasable mounting systems shown on towed camping trailers. Each includes arrangements for releasably receiving variously mounted accessories, sub-systems and related articles upon the trailer.

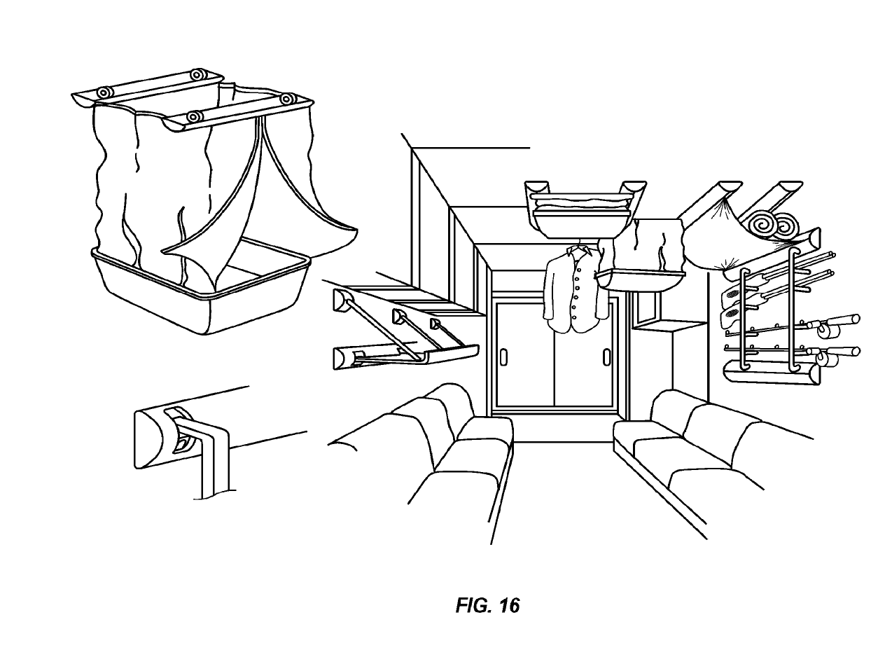

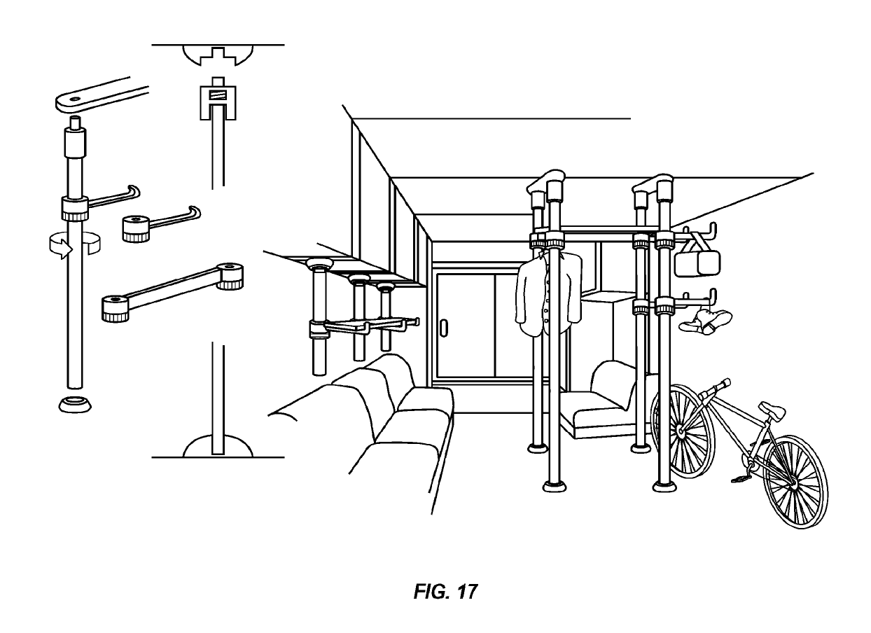

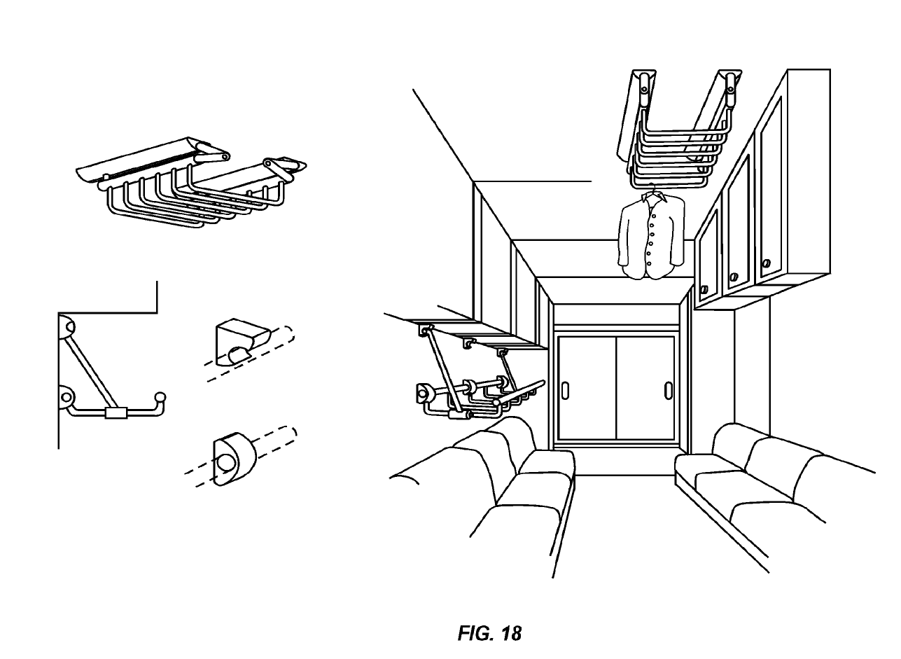

FIGS. 16-18 show different systems for affecting variously configured mountings inside a vehicle. As mentioned above, it can be readily appreciated that like arrangements can be located in such places as the user's garage, attic or a personal recreation area such as a lake-side camper hook-up facility.

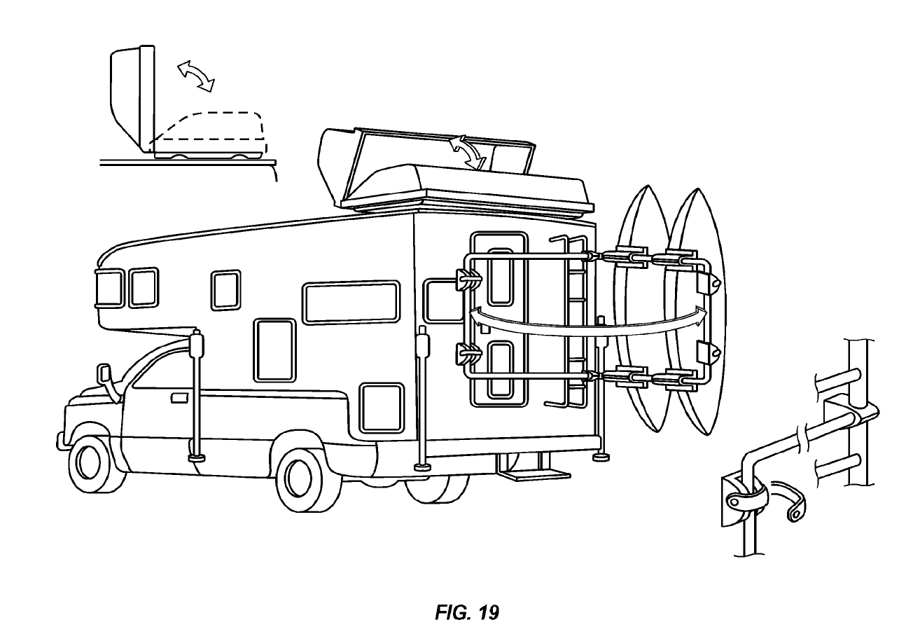

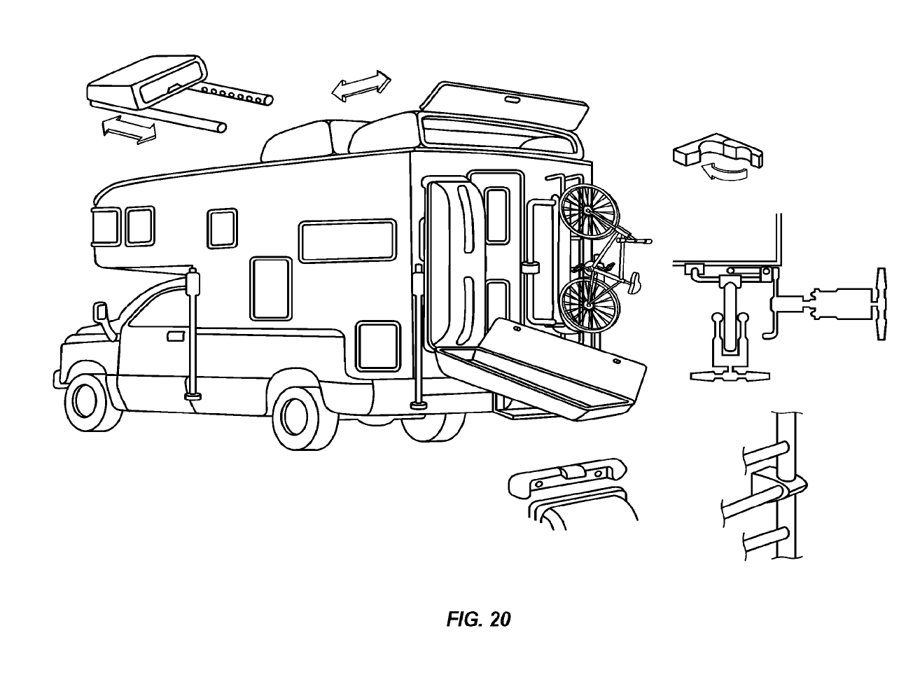

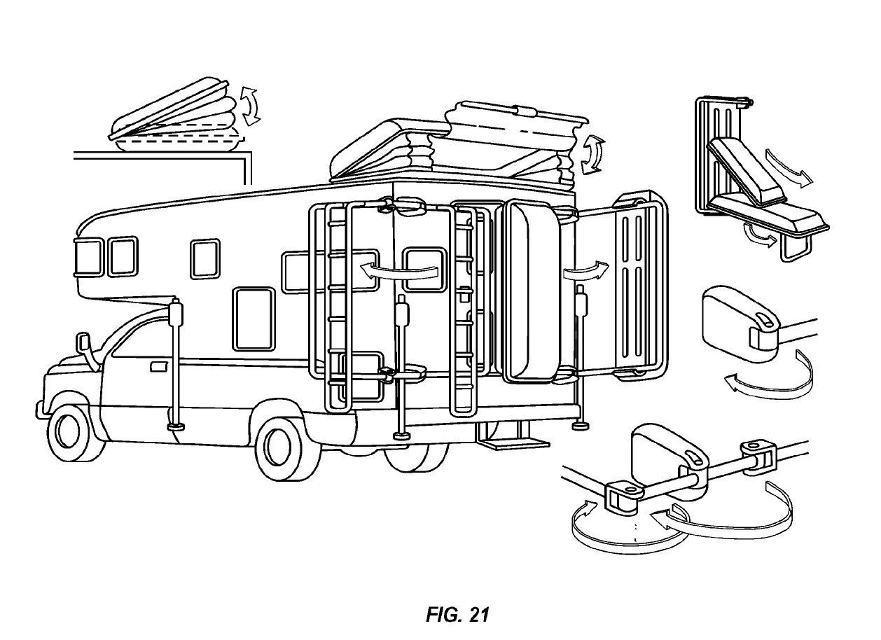

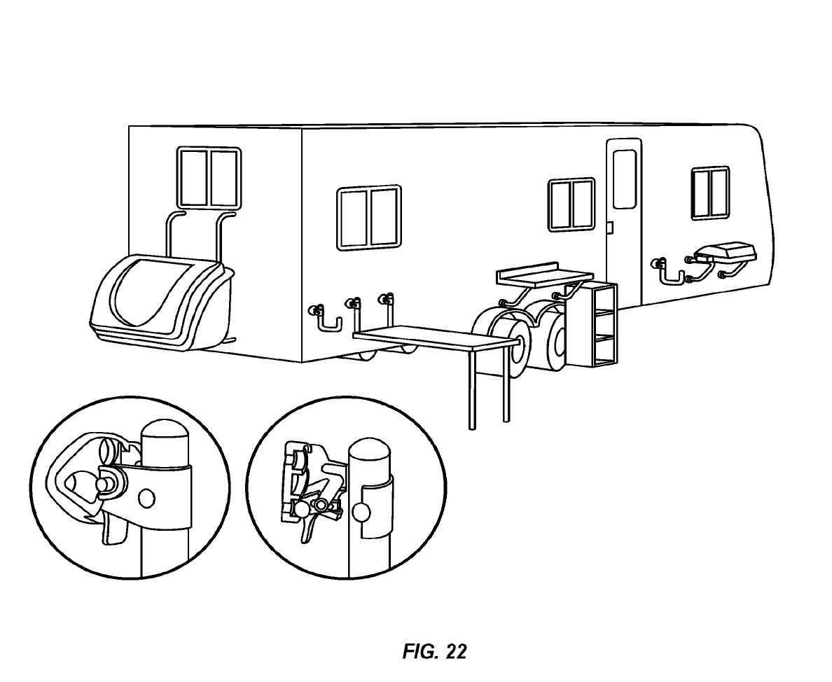

FIGS. 19-21 show swinging arrangements that can be variously mounted to the vehicle, and through which further versatility is provided to the user.

FIGS. 22-31 illustrate various examples of an “elongate support track” concept in which an elongate receiver is provided of substantially uniform cross section and upon which various attachments can be made. As shown, the elongate receiver takes the form of a substantially cylindrical rod. The elongate nature of the receiver permits smaller objects to be supported thereupon at variously selectable locations. It also permits larger objects having multiple hangers to also be accommodated.

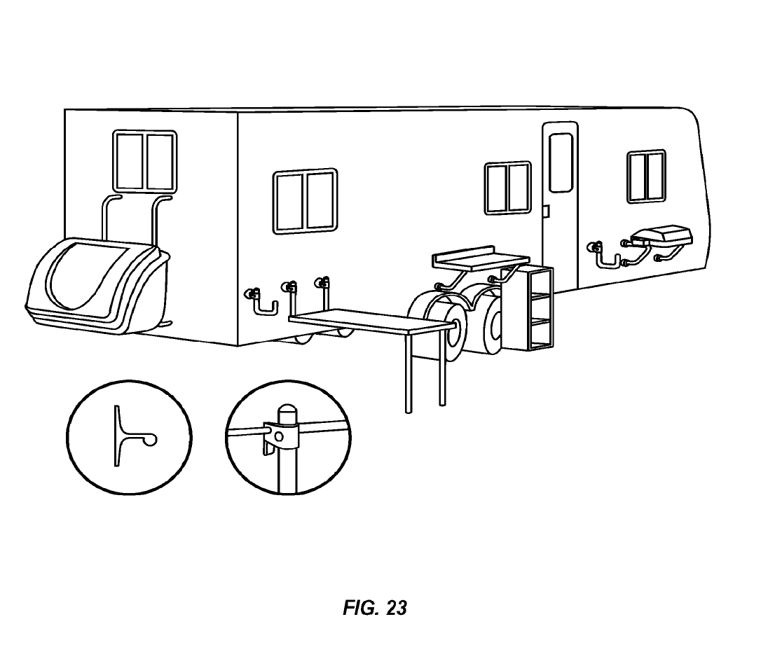

As most aptly shown in FIG. 23, a table having two parallel hangers can be located at many positions along the wall-mounted rod-shaped receiver. The important aspect of the elongate solution is that it further enhances the versatility of the disclosed system when included as a component. In the blow-up details of each of FIGS. 22 and 23, exemplary hanger couplings are illustrated which accommodate hanging at various locations along the provided elongate receiver.

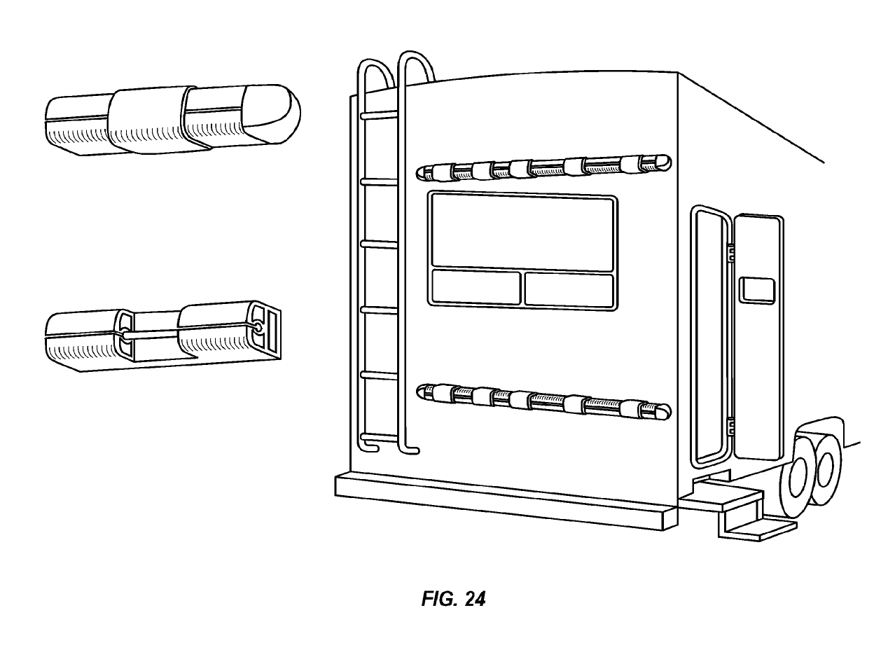

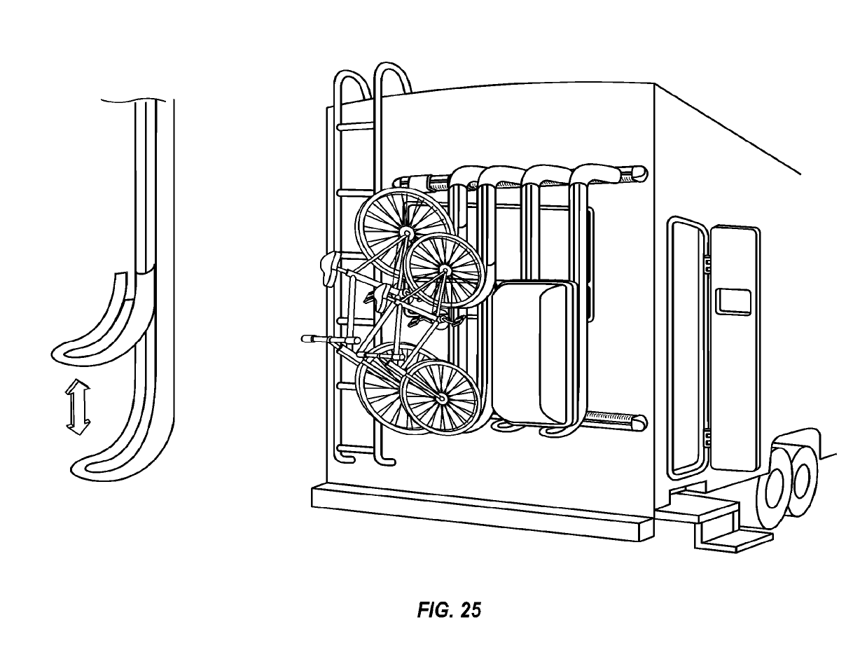

An alternatively designed elongate support bar is shown in FIGS. 24-31. In FIG. 24, the aluminum extruded support bar is shown having five possible hanger-receiver locations are each shown as having a sliding cover thereover when not in use. Details of the bar, connection points, sliding cover and an endcap are shown in the blow-up at the left-hand side of FIG. 24.

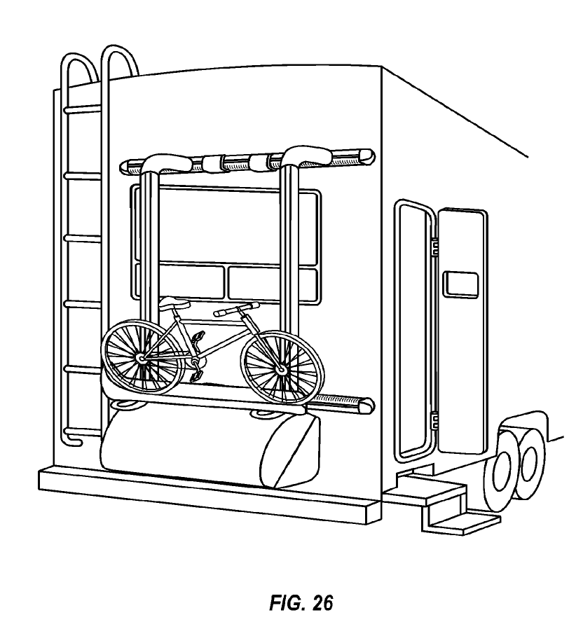

FIG. 25 depicts a pair of bicycles and a ladder-mounted cargo box installed upon a pair of elongate support bars. At the left, a mating insert configured for insertion into one of the hanger-receiver locations of the support bar is shown as a tip adaptation to the vertical support rod located behind the bike rack wheel tray.

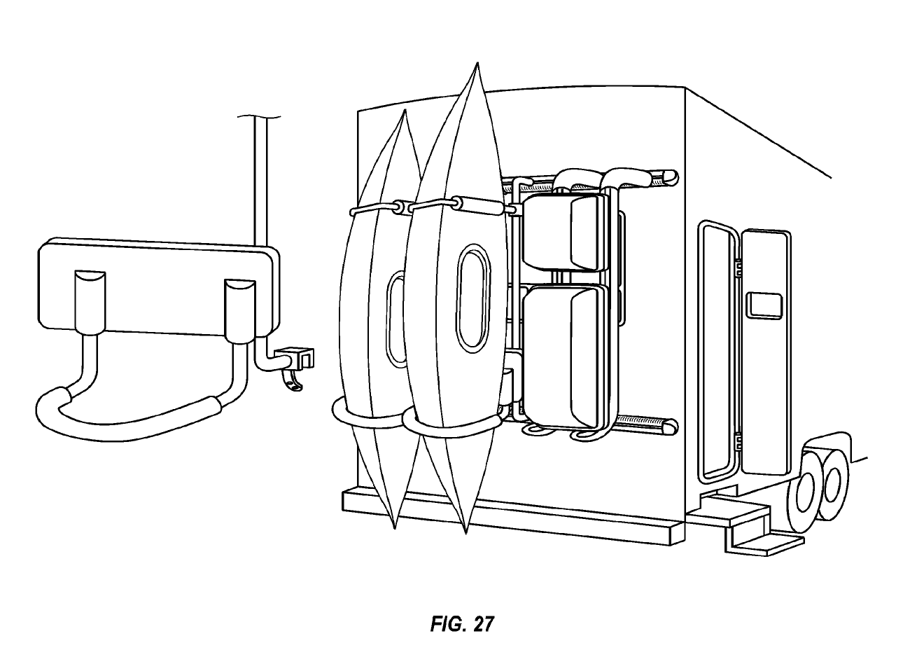

FIG. 26 also shows a pair of bicycles and a cargo box mounted on the pair of elongate support bars, but in this example, the bicycles are maintained in an upright orientation.

FIG. 27 depicts an alternative arrangement on the pair of elongate support bars in which two kayaks and a pair of cargo boxes are hung from the vehicle on the support bars.

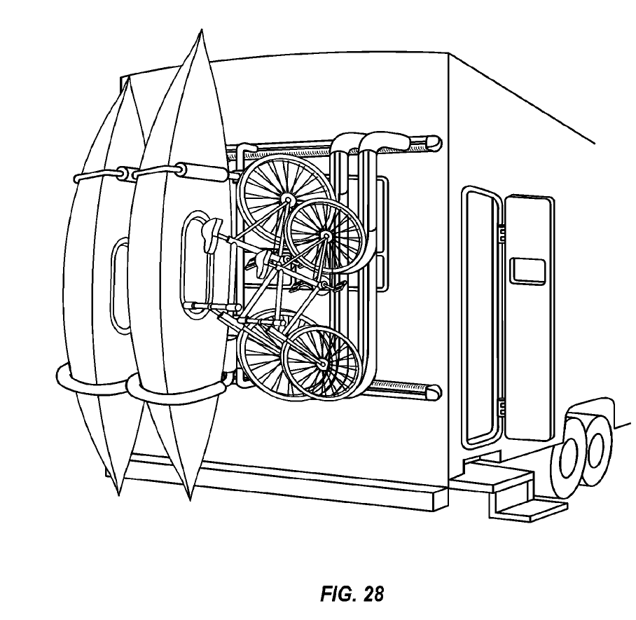

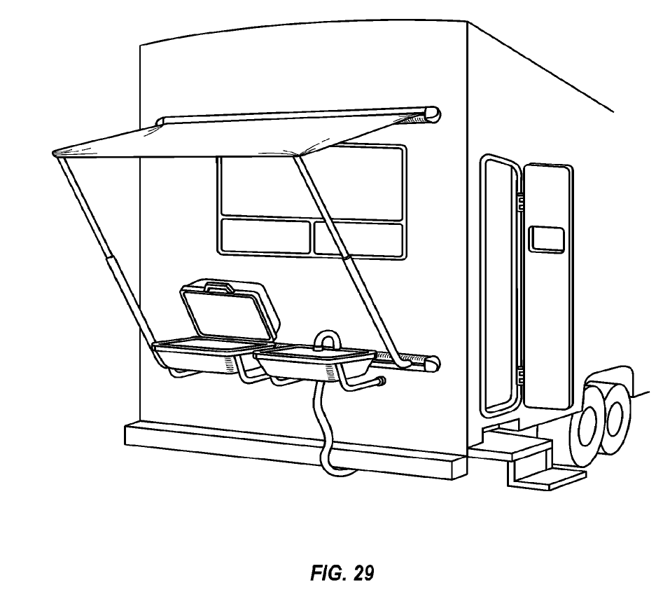

FIG. 28 shows an arrangement on the pair of elongate support bars in which two kayaks and a pair of bicycles are hung from the vehicle on the support bars.

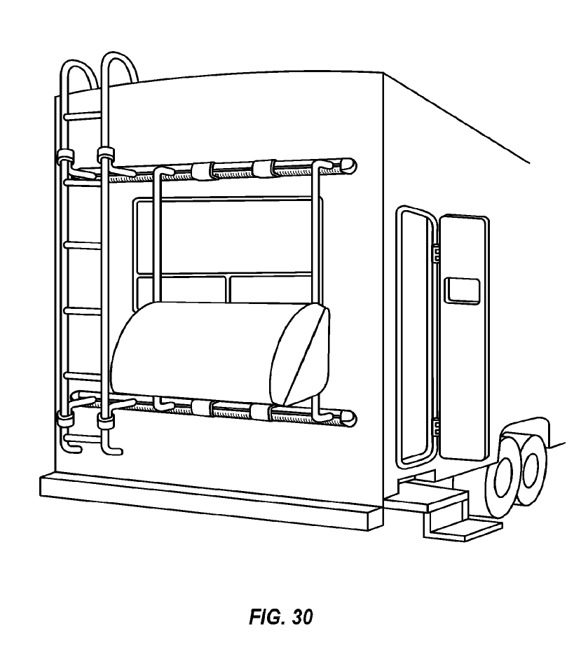

FIG. 29 depicts an awning, wash basin and cooking grill mounted on the pair of support bars.

FIG. 30 shows a ladder and cargo box, each mounted between the pair of support bars.

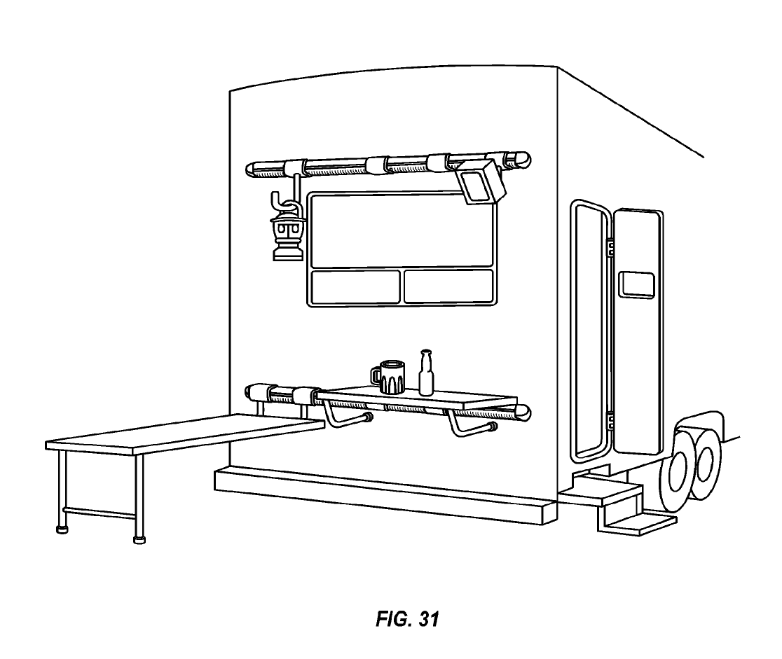

FIG. 31 shows a lantern hung on a j-hook that in turn hangs from one of the hanger-receiver locations on the top one of the support bars. An LCD television is mounted on a support that has an insert portion received in another of the hanger-receiver locations on that same upper support bar. On the lower support bar, a table and cantilevered counter surface are supported.

### INDUSTRIAL APPLICABILITY

The present invention finds applicability in at least the camping, travel, recreational vehicle and related leisure industries.

What is claimed and desired to be secured by Letters Patent is as follows:

1. An article organizing and mounting system configured for use on a recreational vehicle, said system comprising a releasable coupling device including a first coupling member providing a hard point when secured to a mounting surface of a recreational vehicle to allow releasable engagement between the hard point and a second releasable coupling member that has a connection to an article to mount the article adjacent to the mounting surface.

2. The article organizing and mounting system as recited in claim 1, wherein the first coupling member is a pod including a housing and a pocket to receive a mating portion of the second coupling member to produce the releasable coupling device attaching the article to the mounting surface.

3. The article organizing and mounting system as recited in claim 2, wherein the first coupling member further includes a cover for the pocket.

4. The article organizing and mounting system as recited in claim 3, wherein the pocket is a substantially U-shaped pocket.

5. The article organizing and mounting system as recited in claim 3, wherein the cover is adapted to deflect to provide access to the pocket for the mating portion of the second coupling member.

6. The article organizing and mounting system as recited in claim 2, wherein the mating portion includes a flat head portion for engaging the pocket for releasable retention therein, the mating portion further including a stem portion between the flat head portion and the connection to the article.

7. The article organizing and mounting system as recited in claim 1, wherein the first coupling element is a rod pod including a housing and a rod to receive a mating portion of the second coupling member to produce the releasable coupling device attaching the article to the mounting surface.

8. The article organizing and mounting system as recited in claim 7, wherein the first coupling member further includes a sliding cover movable to present the rod for releasable engagement of the mating portion of the second coupling member.

9. The article organizing and mounting system as recited in claim 8, wherein the mating portion includes a clamp portion for engaging the rod for releasable retention thereto, the mating portion further including a stem portion between the clamp portion and the connection to the article.

10. The article organizing and mounting system as recited in claim 1, wherein the article is selected from the group consisting of an awning, a ladder, a sports equipment carrier, a barbecue grill, a shelf and a storage container.

11. The article organizing and mounting system as recited in claim 1, wherein the mounting surface is a surface portion of a recreational vehicle.

12. The article organizing and mounting system as recited in claim 11, wherein the surface portion is selected from the group consisting of inside surface portions and outside surface portions of the recreational vehicle.

13. A system for accommodating mounting of an article at various locations about a recreational vehicle, the system comprising a plurality of receivers configured to be at least semi-permanently coupled to an exterior surface of a recreational vehicle, each of said receivers being adapted to releasably receive an insert member associated with an article to be suspended from the vehicle at a location proximate the respective receiver.

14. A method for accommodating varied placement of a hanging article about a recreational vehicle, said method comprising providing a plurality of hanger-receiver locations on at least one substantially vertical surface of a recreational vehicle and said plurality of hanger-receiver locations providing a plurality of releasable hanging positions for a hanging article about the recreational vehicle.

15. The method as recited in claim 14, wherein each hanger-receiver location is provided in a mounted member that is semi-permanently fixed to a substantially vertical surface of the recreational vehicle.

16. The method as recited in claim 15, wherein each hanger-receiver location comprises a trap-space in which a necked hanger connected to the hanging article inserts in releasable, trapped engagement therewith.

17. The method as recited in claim 15, wherein each hanger-receiver location comprises a receiving space in which an insert portion connected to the hanging article inserts in releasable engagement therewith.

18. The method as recited in claim 15, wherein at least one of the releasable hanging positions for a hanging article is on an interior substantially vertical surface of the recreational vehicle.

19. The method as recited in claim 15, wherein at least one of the releasable hanging positions for a hanging article is on an exterior substantially vertical surface of the recreational vehicle.

20. The method as recited in claim 19, wherein at least one of the releasable hanging positions for a hanging article is on an interior substantially vertical surface of the recreational vehicle.

21. A method for providing sets of hanger-receivers that when installed, provide a plurality of locations that accommodate varied placement of a hanging article about a recreational vehicle, said method comprising:
obtaining a plurality of hanger-receivers and advocating the sale of said hanger-receivers to third parties in sets of at least two hanger-receivers; and
advocating semi-permanent installation of sets of said hanger-receivers at different locations about a recreational vehicle on substantially vertical surfaces thereof to thereby enable a user of the incorporating recreational vehicle to establish a plurality of releasable hanging positions for a hanging article about the recreational vehicle.

22. The method as recited in claim 21, wherein each hanger-receiver comprises a trap-space in which a necked hanger connected to a hanging article inserts in releasable, trapped engagement therewith.

23. The method as recited in claim 21, wherein each hanger-receiver comprises a receiving space in which an insert portion connected to a hanging article inserts in releasable engagement therewith.

24. The method as recited in claim 21, further comprising advocating that at least one of the releasable hanging positions be on an interior substantially vertical surface of the recreational vehicle.

25. The method as recited in claim 21, further comprising advocating that at least one of the releasable hanging positions be on an exterior substantially vertical surface of the recreational vehicle.

26. The method as recited in claim 25, further comprising advocating that at least one of the releasable hanging positions be on an interior substantially vertical surface of the recreational vehicle.
